(19) United States
(12) Patent Application Publication
(10) Pub. No.: US 2010/0118199 A1
(43) Pub. Date: May 13, 2010

(54) Video/Audio Processor and Video/Audio Processing Method

(75) Inventor: Daisuke Kobayashi, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/411,203

(22) Filed: Mar. 25, 2009

(30) Foreign Application Priority Data
Nov. 10, 2008 (JP) 2008-288176

(51) Int. Cl. H04N 9/74

(52) U.S. Cl. 348/578; 348/E09.055

(57) ABSTRACT

A video/audio processor includes: a position calculation unit configured to calculate from a video signal a position of a speaking person in a screen; and an adjustment section configured to adjust a signal level of a specific frequency of an audio signal inputted to a plurality of speakers in correspondence with the position of the speaking person calculated in the position calculation unit, for each of the plurality of speakers independently.

### CROSS-REFERENCE TO RELATED APPLICATIONS

This application is based upon and claims the benefit of priority from the prior Japanese Patent Application No. 2008-288176, filed on Nov. 10, 2008; the entire contents of which are incorporated herein by reference.

### BACKGROUND OF THE INVENTION

1. Field of the Invention

The present invention relates to a video/audio processor and a video/audio processing method.

2. Description of the Related Art

Conventionally, with respect to a video/audio processor, there is proposed a method in which a position of a speaking person in video is detected and volume of a plurality of speakers is controlled based on the detected position of the speaking person in the video in order to enhance feeling of presence at a time that monaural audio is outputted (JP-A 11-313272(KOKAI)).

### BRIEF SUMMARY OF THE INVENTION

However, in a conventional video/audio processor, volume of not only audio of a speaking person but also of sound effects such as BGM is controlled. Thus, a viewer is given a sense of incompatibility. In view of the above, an object of the present invention is to provide a video/audio processor and a video/audio processing method capable of providing a viewer with natural feeling of presence at a time that monaural audio is outputted.

A video/audio processor according to an aspect of the present invention includes: a position calculation unit configured to calculate from a video signal a position of a speaking person in a screen; and an adjustment section configured to adjust a signal level of a specific frequency of an audio signal inputted to a plurality of speakers in correspondence with the position of the speaking person calculated in the position calculation unit, for each of the plurality of speakers independently.

A video/audio processing method according to an aspect of the present invention includes: calculating from a video signal a position of a speaking person in a screen; and adjusting a signal level of a specific frequency of an audio signal inputted to a plurality of speakers in correspondence with the position of the speaking person calculated in the calculating a position of a speaking person, for each of the plurality of speakers independently.

### BRIEF DESCRIPTION OF THE DRAWINGS

FIG. 1 is a diagram showing an example of a constitution of a video/audio processor according to a first embodiment.

FIG. 2 is a diagram showing an example of a speaker disposition.

FIG. 3 is a diagram showing an example of a constitution of a position calculation unit.

FIG. 4A is a view showing an example of a block disposition according to the first embodiment.

FIG. 4B is a view showing another example of a block disposition according to the first embodiment.

FIG. 5A is a table showing an example of a relation between an area and a block.

FIG. 5B is a table showing another example of a relation between an area and a block.

FIG. 6 is a diagram showing an example of a constitution of an audio processing unit.

FIG. 7A is a graph showing an attenuation amount of a signal level in Ch A.

FIG. 7B is a graph showing an attenuation amount of a signal level in Ch B.

FIG. 7C is a graph showing an attenuation amount of a signal level in Ch C.

FIG. 7D is a graph showing an attenuation amount of a signal level in Ch D.

FIG. 8 is a flowchart showing an operation of a video/audio processor according to the first embodiment.

FIG. 9 is a diagram showing an example of a constitution of a video/audio processor according to a modification example of the first embodiment.

FIG. 10 is a diagram showing an example of a constitution of a position calculation unit according to the modification example of the first embodiment.

FIG. 11 is a diagram showing an example of a constitution of a video/audio processor according to a second embodiment.

FIG. 12 is a diagram showing an example of a constitution of an audio processing unit.

FIG. 13 is a diagram showing an example of a constitution of an amplifying section.

### DETAILED DESCRIPTION OF THE EMBODIMENTS

Hereinafter, embodiments of the present invention will be described in detail with reference to the drawings.

### First Embodiment

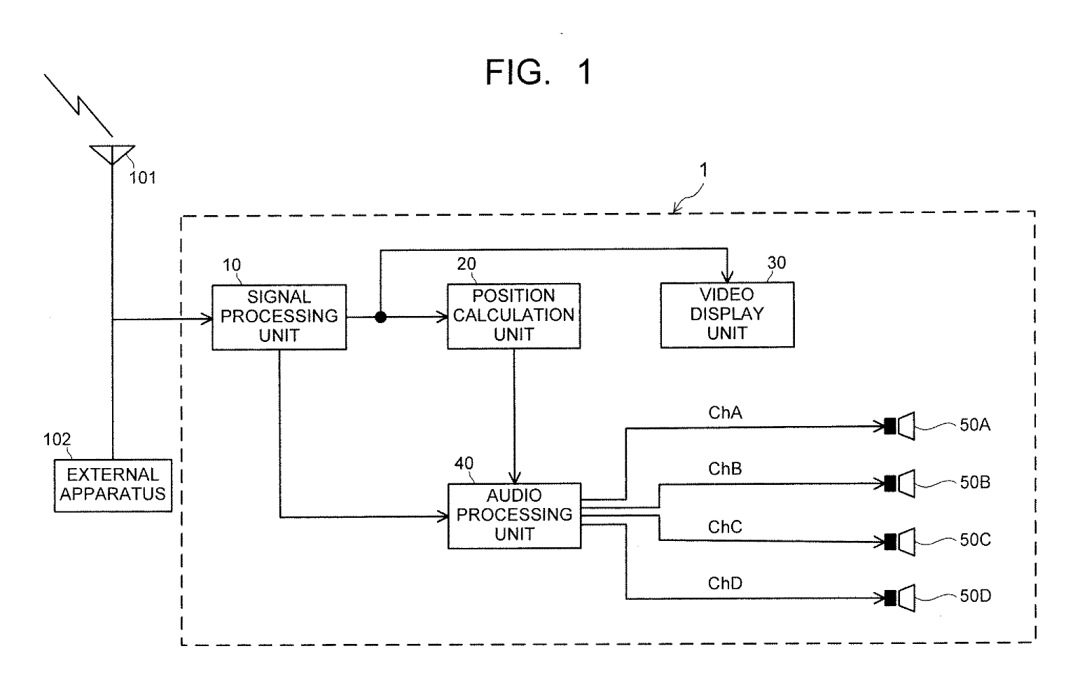

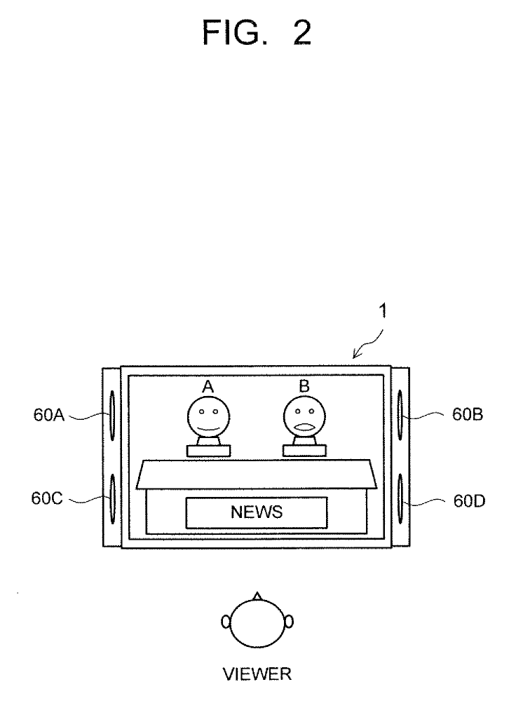

FIG. 1 is a diagram showing an example of a constitution of a video/audio processor 1 according to a first embodiment. FIG. 2 is a diagram showing an example of disposition of speakers 50A to 50D. The first embodiment will be described in an example of a video display apparatus such as a CRT (Cathode Ray Tube) or a liquid crystal TV as the video/audio processor 1.

The video/audio processor 1 according to the first embodiment includes a signal processing unit 10, a position calculation unit 20, a video display unit 30, an audio processing unit 40, speakers 50A to 50D.

The signal processing unit 10 demodulates a video signal and an audio signal inputted from an antenna 101 or an external apparatus 102. The external apparatus 102 is a video tape recording/reproducing apparatus, a DVD recording/reproducing apparatus or the like. The signal processing unit 10 inputs the demodulated video signal to the position calculation unit 20 and the video display unit 30. The signal processing unit 10 inputs the demodulated audio signal to the audio processing unit 40.

The video display unit 30 generates video from the video signal inputted from the signal processing unit 10. Then, the video display unit 30 displays the generated video.

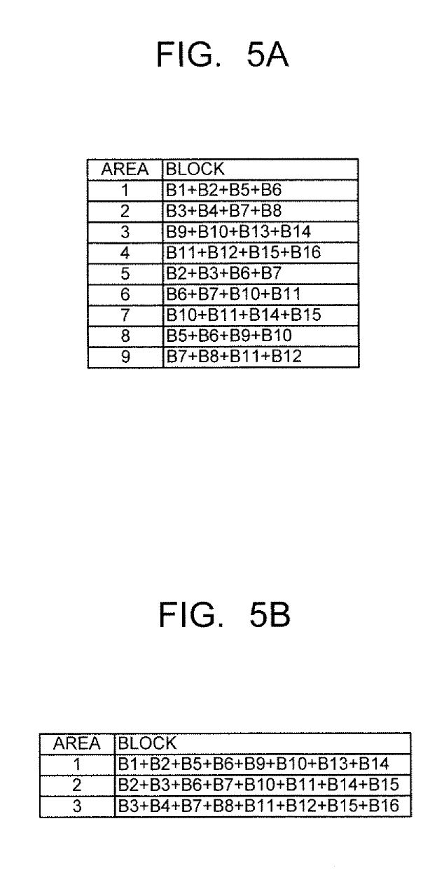

The position calculation unit 20 detects a mouth of a speaking person from the video signal inputted from the signal processing unit 10. The position calculation unit 20 calculates position coordinates of the detected mouth of the speaking person. The position calculation unit 20 judges to which area among areas described later in FIG. 5A the calculated position coordinates belong. The position calculation unit 20 inputs a judgment result to the audio processing unit 40. It should be noted that the position calculation unit 20 detects the mouth of the speaking person under a condition that a face of the speaking person is ivory colored and that the mouth has motion.

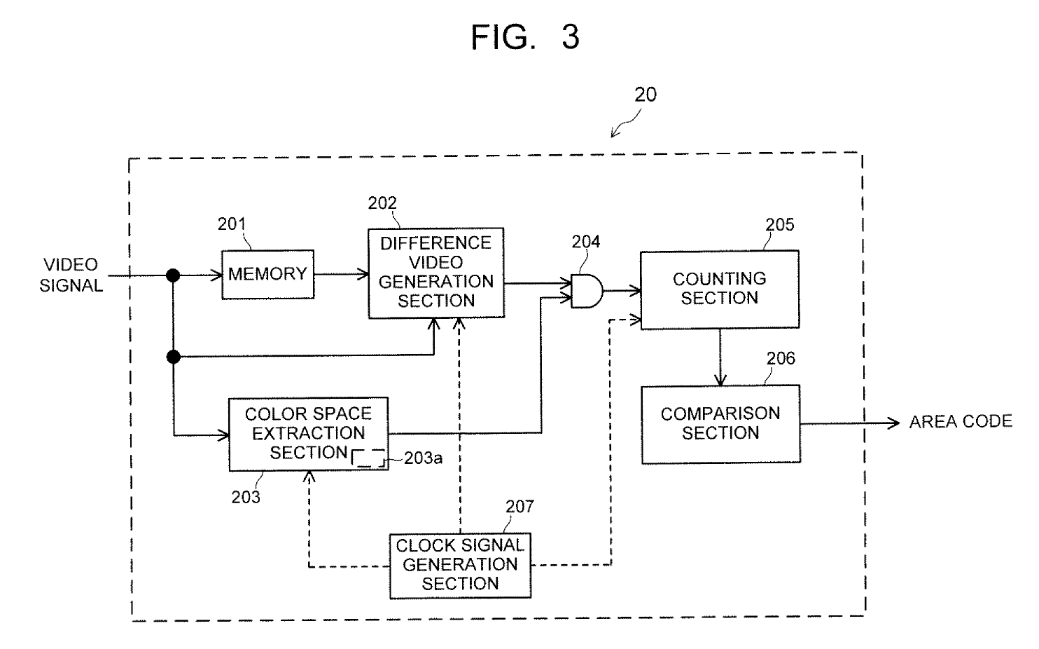

FIG. 3 is a diagram showing an example of a constitution of the position calculation unit 20. The position calculation unit 20 includes a memory 201, a difference video generation section 202, a color space extraction section 203, an AND circuit 204, a counting section 205, and a comparison section 206.

A video signal of one frame is stored in the memory 201. The video signal stored in the memory 201 is inputted to the difference video generation section 202 in a delayed manner by one frame. The difference video generation section 202 generates a difference signal between the video signal inputted from the signal processing unit 10 and the video signal inputted from the memory 201 in a delayed manner by one frame.

The difference video generation section 202 generates an absolute value signal obtained by calculating an absolute value of the difference signal. Further, the difference video generation section 202 performs an offset processing and a filtering processing on the absolute value signal in order to remove noise. Then, the absolute value signal after the offset processing and the filtering processing is inputted to the AND circuit 204 as a detection signal.

In other words, the difference video generation section 202 inputs the detection signal corresponding to a pixel having a difference between frames, that is, a pixel having motion, to the AND circuit 204. It should be noted that the difference video generation section 202 inputs the detection signal to the AND circuit 204 synchronously with a clock signal inputted from a clock signal generation section 207. The difference video generation section 202 inputs the detection signal to the AND circuit 204, in an arbitrary order, starting from a pixel in the upper left of the video.

The color space extraction section 203 includes a memory 203a. A threshold value of a color difference signal determined by an experiment or the like is stored in the memory 203a in advance. The threshold value of the color difference signal is used for detection of the mouth of the speaking person. In the first embodiment, a threshold value of a color difference signal SC is set at a value to detect an ivory color. In the first embodiment, an HSV space is used as a color space. Further, for a color difference signal, a hue and a chroma are used.

The color space extraction section 203 judges for each pixel whether or not the inputted color difference signal of the video signal is within a range of the threshold value stored in the memory 203a. If the color difference signal of the video signal is within the range of the above-described threshold value, the color space extraction section 203 inputs a detection signal to the AND circuit 204. The color space extraction section 203 inputs the detection signal to the AND circuit 204 synchronously with the clock signal inputted from the clock signal generation section 207.

In other words, the color space extraction section 203 inputs a detection signal corresponding to an ivory colored pixel to the AND circuit 204. The color space extraction section 203 inputs the detection signal to the AND circuit 204 in the same order as in the difference video generation section 202. It should be noted that in the first embodiment, the color space extraction section 203 detects an ivory colored region. However, after the ivory colored region is detected, a red color can be detected from the ivory colored region. Thereby, the mouth of the speaking person can be detected more effectively. Meanwhile, a skin color is different by person. Therefore, it is a matter of course that a plurality of colors can be set to be detected.

The AND circuit 204 obtains a logical multiplication of the detection signals inputted from the difference video generation section 202 and the color space extraction section 203. In other words, when the detection signals inputted from the difference video generation section 202 and the color space extraction section 203 are inputted, a signal is inputted to the counting section 205. As a result that the logical multiplication of the detection signal inputted from the difference video generation section 202 and the detection signal inputted from the color space extraction section 203 is obtained in the AND circuit 204, the pixel having the ivory color and motion, that it, the pixel corresponding to the mouth of the speaking person can be detected effectively.

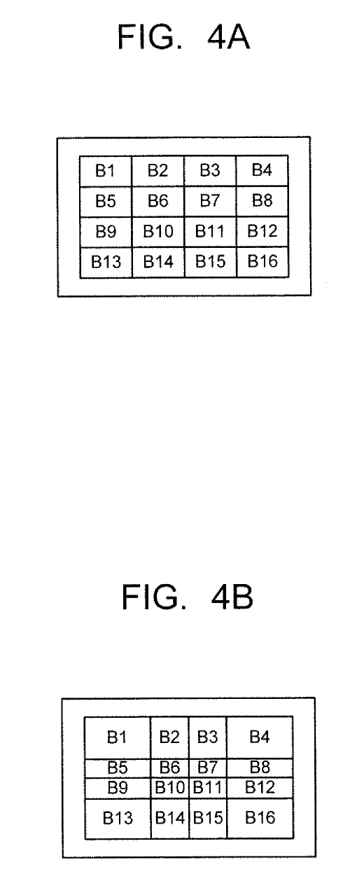

The counting section 205 counts the number of signals inputted from the AND circuit 204. The number of signals is counted for each block described later in FIG. 4A. The counting section 205 judges the pixel of which position in the video the signal inputted from the AND circuit 204 corresponds to, based on the clock signal inputted from the block signal generation section 207.

FIG. 4A is a diagram showing an example of a block arrangement according to the first embodiment. In this example, an example is shown in which a screen of the video display unit 30 is divided into sixteen equal parts, each of sixteen equally divided regions being one block. In other words, the screen of the video display unit 30 is constituted with sixteen blocks in total from a block B1 to a block 1316.

The arrangement of the blocks shown in FIG. 4A is an example. It is possible, for example, as shown in FIG. 4B, to divide so that areas of blocks belonging to a center region of video, that is, blocks B6, B7, B10 and B11 are small and areas of blocks belonging to an outer peripheral region of the video, that is, from a block B1 to a block B5, a block B8, a block B9, and a block B12 to a block B16 are large. Usually, the speaking person is projected in the center region of the video. Thus, making the area of each block in the center region of the video small leads to effective detection of the mouth of the speaking person in the screen.

The counting section 205 judges to which block the signal inputted from the AND circuit 204 belongs. The counting section 205 counts the number of the signals inputted from the AND circuit 204 for each block. Then, the counting section 205 inputs a count number for each block together with a block code to the comparison section 206.

The comparison section 206 calculates a sum of the count numbers for each area described later in FIG. 5A. The comparison section 206 compares the calculated sums of the count numbers and inputs a code of the area having the highest sum of the count numbers to the audio processing unit 40.

FIG. 5A is a table showing an example of a relation between the area and the block. An area 1 is constituted with the blocks B1, B2, B5 and B6. An area 2 is constituted with the blocks B3, B4, B7 and B8. An area 3 is constituted with the blocks B9, B10, B13 and B14.

Further, an area 4 is constituted with the blocks B11, B12, B15 and B16. An area 5 is constituted with the blocks B2, B3, B6 and B7. An area 6 is constituted with the blocks B6, 37, B10 and B11. An area 7 is constituted with blocks B10, B11, B14 and B15. An area 8 is constituted with the blocks B5, B6, B9 and B10. An area 9 is constituted with the blocks B7, B8, B11 and B12.

The relation between the area and the block shown in FIG. 5A is an example, and is altered depending on the number and disposition of speakers connected to the video/audio processor 1. For example, when one speaker is each disposed on the right and the left of the video display unit 30, areas can be set as shown in FIG. 5B. Further, an area and a block can be corresponded one-to-one. In this case, the mouth of the speaking person is detected for each block.

The audio processing unit 40 inputs the audio signal inputted from the signal processing unit 10 to the speakers 50A to 50D. A path for inputting the audio signal to the speaker 50A is referred to as Ch (channel) A. A path for inputting the audio signal to the speaker 50B is referred to as Ch B. A path for inputting the audio signal to the speaker 50C is referred to as Ch C. A path for inputting the audio signal to the speaker 50D is referred to as Ch D. The audio processing unit 40 attenuates a signal level of a specific frequency of the audio signal inputted to the speakers 50A to 50D in correspondence with the area code inputted from the position calculation unit 20.

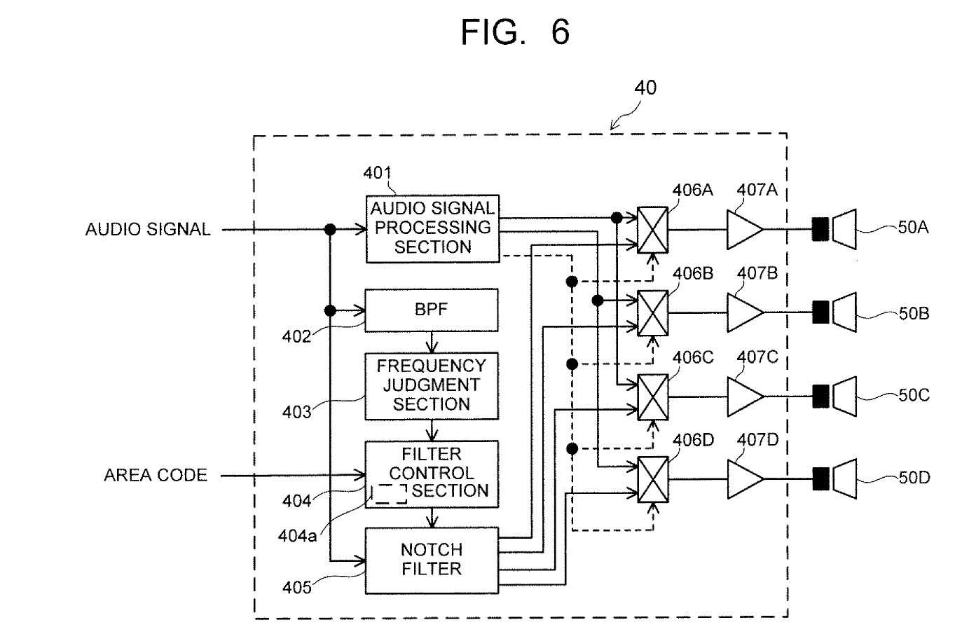

FIG. 6 is a diagram showing an example of a constitution of the audio processing unit 40. The audio processing unit 40 includes an audio signal processing section 401, a BPF (band pass filter) 402, a frequency judgment section 403, a filter control section 404, a notch filter 405 (adjustment section), selectors 406A to 406D and amplifiers 407A to 407D.

The audio signal processing section 401 inputs the audio signal inputted from the signal processing unit 10 to the selectors 406A to 406D. The audio signal processing section 401 judges whether the audio signal is monaural or stereo. When a judgment result indicates monaural, the audio signal processing section 401 controls the selectors 406A to 406D to switch connection destinations of the amplifiers 407A to 407D to the notch filter 405. Meanwhile, when the judgment result indicates stereo, the audio signal processing section 401 controls the selectors 406A to 406D to switch the connection destinations of the amplifiers 407A to 407D to the audio signal processing section 401.

The BPF 402 passes an audio signal of a frequency band (about 0.5 kHz to 4 kHz) of human conversation sound among the audio signals received by the audio processing unit 40.

The frequency judgment section 403 judges a frequency of the highest signal level from a spectrum of the audio signal passed through the BPF 402.

The notch filter 405 is a 4-channel notch filter including Ch A to Ch D. The notch filter 405 distributes an inputted audio signal to Ch A to Ch D. Then, the notch filter 405 attenuates a specific frequency of the audio signal, independently for Ch A to Ch D.

An attenuation amount of the audio signal and the specific frequency in the notch filter 405 are controlled by the filter control section 404. Further, attenuation of the audio signal in the notch filter 405 is realized by adjusting a Q value of the notch filter 405.

The audio signal attenuated in Ch A is inputted to the selector 406A. The audio signal attenuated in Ch B is inputted to the selector 406B. The audio signal attenuated in Ch C is inputted to the selector 406C. The audio signal attenuated in Ch D is inputted to the selector 406D.

The filter control section 404 includes a memory 404a. In the memory 404a is stored table data in which the area codes explained in FIG. 5 are corresponded with the attenuation amounts of the signal levels of the audio signals in Ch A to Ch D of the notch filter 405.

The filter control section 404 sets a center frequency of the notch filter 405 at the frequency judged in the frequency judgment section 403. Further, the filter control section 404 refers to the table data stored in the memory 404a. Then, the filter control section 404 controls the attenuation amount of the notch filter 405 to be the value corresponding to the area code inputted from the position calculation unit 20.

The attenuation amounts of the signal levels of the audio signals in Ch A to Ch D are determined in correspondence with distances from center positions of respective areas to the respective speakers 50A to 50D. In the first embodiment, as the distances from the position of the speaking person to the respective speakers 50A to 50D get far (long), the attenuation amounts of the notch filter 405 are made large (deep).

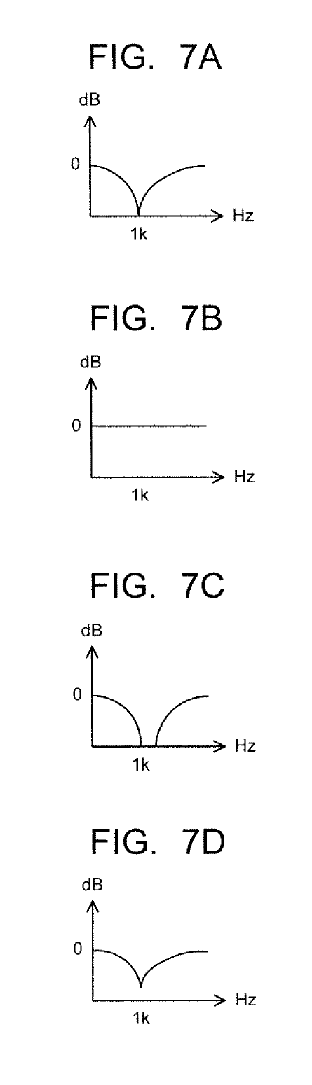

For example, when the speakers 50A to 50D are disposed as in FIG. 2 and a person B is the speaking person, attenuation amounts of the signal levels in Ch A to Ch D are as shown in FIG. 7A to FIG. 7D.

FIG. 7A is a graph showing the attenuation amount of the signal level in Ch A. FIG. 7B is a graph showing the attenuation amount of the signal level in Ch B. FIG. 7C is a graph showing the attenuation amount of the signal level in Ch C. FIG. 7D is a graph showing the attenuation amount of the signal level in Ch D.

In Ch C corresponding to the speaker 50C, which is the farthest in distance from the person B, as a result of adjustment of the Q value, the attenuation amount of the signal level is set deepest. In contrast, in Ch B corresponding to the speaker 50B, which is the nearest in distance from the person B, as a result of adjustment of the Q value, the attenuation amount of the signal level is set smallest (shallowest).

As stated above, as a result that the attenuation amount of the notch filter 405 is increased as the distances between the center positions of the areas and the respective speakers 50A to 50D get longer, it is possible to assign audio to a neighborhood of the position of the speaking person effectively. Consequently, an effect can be obtained that audio sounds from the neighborhood of the position of the speaking person. Besides, the frequency of the highest signal level of the frequencies passed through the BPF 402 is attenuated. Therefore, as for sound effects and the like other than the audio of the speaking person B, it is possible to effectively restrain change of assignment of audio.

It should be noted that the notch filter 405 can be controlled by using an attenuation ratio instead of the attenuation amount as a control parameter by the filter control section 404.

The amplifiers 407A to 407D each amplify the audio signal inputted from the selectors 406A to 406D by a predetermined gain.

The speakers 50A to 50D each convert the amplified audio signal inputted from the amplifiers 407A to 407D into an acoustic wave and radiate into the air.

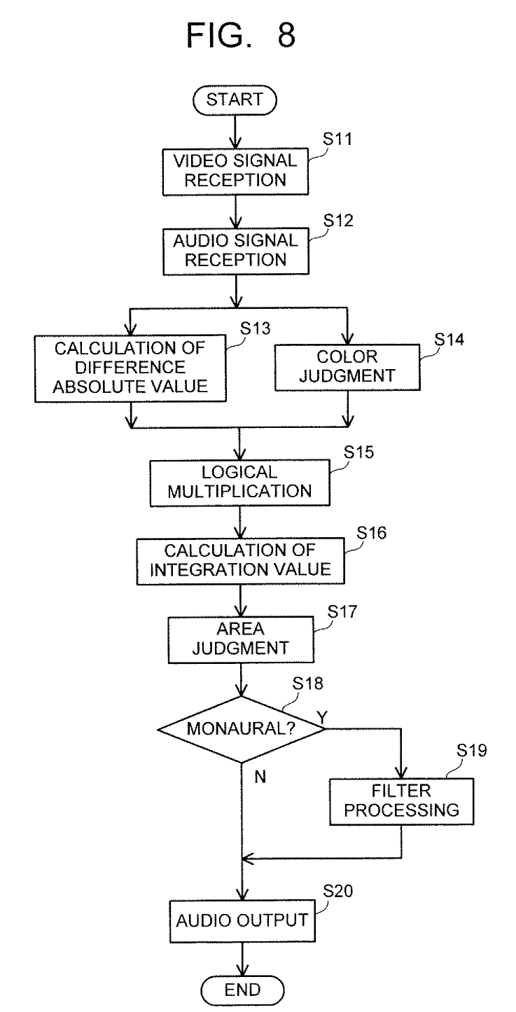

Next, an operation will be described. FIG. 8 is a flowchart showing an operation of a video/audio processor 1 according to the first embodiment.

A signal processing unit 10 receives a video signal (step S11). An audio processing unit 40 receives an audio signal (step S12). A difference video generation section 202 generates an absolute value signal obtained by calculating an absolute value of a difference signal of the video signals between frames (step S13). The difference video generation section 202 performs an offset processing and a filtering processing on the generated signal and inputs to an AND circuit 204 as a detection signal.

A color space extraction section 203 of a position calculation unit 20 judges whether or not a color difference signal of the video signal is within a range of a threshold value stored in a memory 203a (step S14). If the color difference signal of the video signal is within the rage of the threshold value, the color space extraction section 203 inputs a detection signal to the AND circuit 204.

When the detection signals inputted from the difference video generation section 202 and the color space extraction section 203 are inputted, the AND circuit 204 inputs a signal to a counting section 205 (step S15).

The counting section 205 of the position calculation unit 20 counts the number of the signals inputted from the AND circuit 204 for each block.

A comparison section 206 of the position calculation unit 20 calculates a sum of the count numbers for each area (step S16). Next, the comparison section 206 compares the sums of the count numbers calculated for each area. The comparison section 206 inputs an area code of the area having the largest sum of the count numbers from a comparison result to the audio processing unit 40 (step S17).

An audio signal processing section 401 of the audio processing unit 40 judges whether the audio signal inputted from the signal processing unit 10 is monaural or stereo (step S18).

When the audio signal is monaural, the audio signal processing section 401 switches the connection destinations of the selectors 406A to 406D to the notch filter 405 (step S19).

A filter control section 404 sets a center frequency of the notch filter 405 at a frequency judged in a frequency judgment section 403. Further, the filter control section 404 refers to table data stored in a memory 404a. Then, the filter control section 404 sets an attenuation amount of the notch filter 405 at a value corresponding to an area code inputted from the position calculation unit 20.

The notch filter 405 distributes the audio signal inputted from the signal processing unit 10 to Ch A to Ch D. The notch filter 405 attenuates signal levels of a specific frequency of the audio signals distributed to Ch A to Ch D and inputs the audio signals to the selectors 406A to 406D, in correspondence with an instruction from the filter control section 404.

The audio signals inputted from the notch filter 405 to the selectors 406A to 406D are amplified in amplifiers 407A to 407D and outputted from speakers 50A to 50D (step S20).

When the audio signal is stereo, the audio signal processing section 401 switches the connection destinations of the selectors 406A to 406D to the audio signal processing section 401.

The audio signals inputted from the audio signal processing section 401 are amplified in the amplifiers 407A to 407D. The audio signals after amplification are outputted from the speakers 50A to 50D (step S20). The video/audio processor 1 continues processings from the steps S11 to S20 while video signals and audio signals are being inputted.

As stated above, in the first embodiment, it is constituted so that in a case of a monaural audio signal, a signal level of a specific frequency of the audio signal is attenuated by the notch filter 405 in correspondence with a position of a speaking person in video. Thus, assignment of audio can be changed so that a voice can sound from the position of the speaking person. Besides, a frequency of the highest signal level of frequencies passed through the BPF 402 is attenuated. Thus, it is possible to effectively restrain change of assignment of audio with respect to sound effects and the like other than the audio of the speaking person. As a result, it is possible to provide a viewer with natural feeling of presence at a time that monaural audio is outputted.

Further, in a case that an audio signal is stereo, the audio signal is directly inputted to the amplifiers 407A to 407D without being passed through the notch filter 405. Thus, in the case that the audio signal is stereo audio, feeling of presence in stereo audio can be obtained. It should be noted that though the mouth position of the speaking person is calculated in the first embodiment, it can be constituted to calculate only the position of the speaking person.

### Modification Example of First Embodiment

A modification example of the first embodiment is different from the first embodiment in a constitution for detecting a mouth position of a speaking person. In the modification example of the first embodiment, an embodiment will be described in which the mouth position of the speaking person is detected after an edge of a face and positions of eyes of the speaking person are detected.

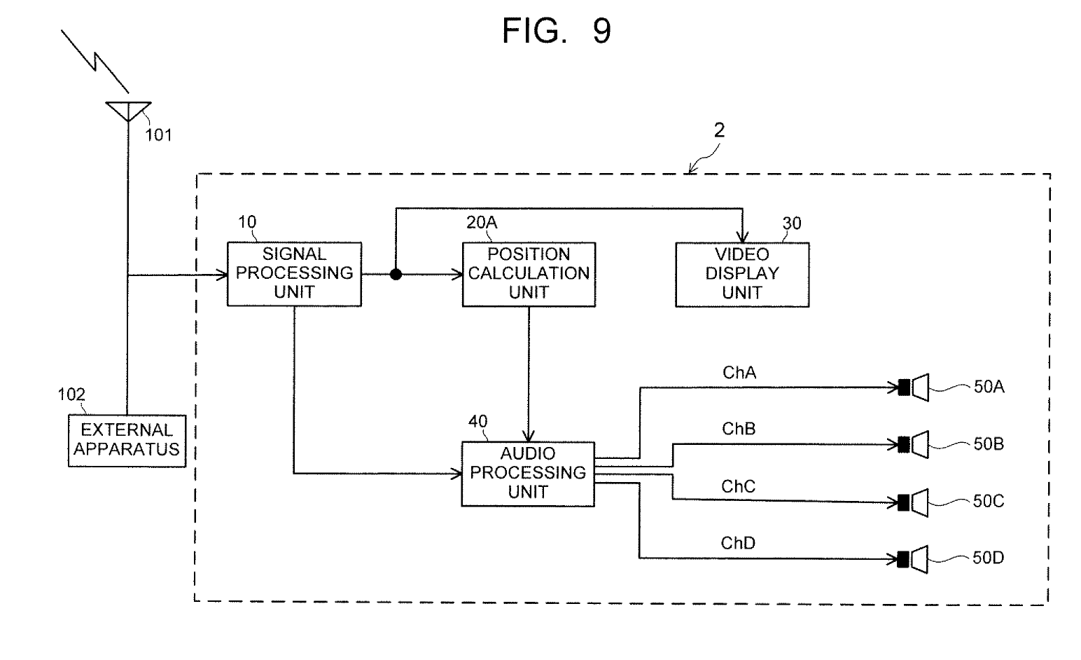

FIG. 9 is a diagram showing an example of a constitution of a video/audio processor 2 according to the modification example of the first embodiment. It should be noted that the video/audio processor 2 according the modification example of the first embodiment is different from the video/audio processor 1 explained in FIG. 1 in a constitution of a position calculation unit 20A. Thus, in the following explanation, the position calculation unit 20A will be described and the same reference numerals and symbols are given to the same components as the components explained in FIG. 1 and duplicate explanation will be omitted.

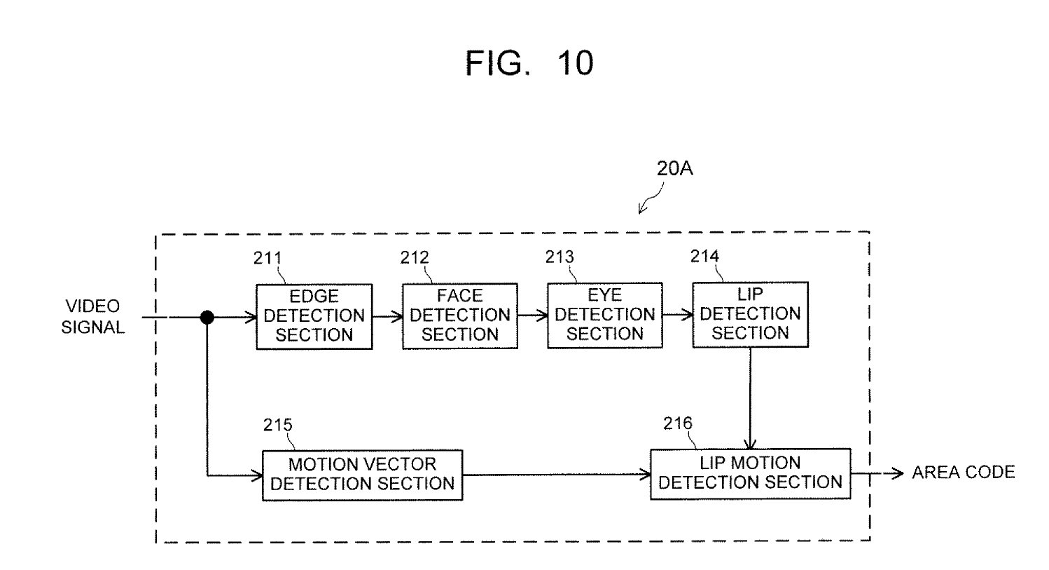

FIG. 10 is a diagram showing an example of a constitution of the position calculation unit 20A. The position calculation unit 20A includes an edge detection section 211, a face detection section 212, an eye detection section 213, a lip detection section 214, a motion vector detection section 215 and a lip motion detection section 216.

The edge detection section 211 detects an edge of video from an inputted video signal. In such edge detection, there is used a phenomenon that signal levels of a luminance signal SY and a color difference signal SC (Pb, Pr) of the video signal change at an edge portion. The edge detection section 211 inputs a luminance signal SY and a color difference signal SC of a detected edge portion to the face detection section 212.

The face detection section 212 detects a region of an ivory colored portion from the video signal. In the detection of the ivory colored region, with a hue of the color difference signal SC inputted from the edge detection section 211 being a standard, the luminance signal SY of the edge portion is masked with the color difference signal SC of the edge portion.

Next, the face detection section 212 judges whether or not the ivory colored region is a face from a shape of the detected ivory colored region. The judgment of whether or not the ivory colored region is the face can be done by means of pattern matching with a stored facial edge pattern. It is better to store a plurality of facial edge patterns.

When judging the detected ivory colored region is the face, the face detection section 212 calculates a size (vertical and horizontal measurement) of the detected face. The face detection section 212 inputs the video signal of the detected face region together with the calculated size of the face to the eye detection section 213.

The eye detection section 213 detects edges of both eyes from the video signal of the face region inputted from the face detection section 212. In this detection of the edges, with a hue by the color difference signal SC being a standard, an edge detection signal obtained by the luminance signal SY is mask-processed. Next, the eye detection section 213 calculates position coordinates of the detected edges of the both eyes.

The lip detection section 214 calculates position coordinates of a mouth from the position coordinates of the edges of the both eyes and the size of the face which are inputted from the eye detection section 213.

The motion vector detection section 215 detects from the luminance signal SY of the video signal a motion vector of the present frame for each block of the video, with a previous frame being a standard, and inputs the motion vector to the lip motion detection section 216. It should be noted that a gradient method, a phase correlation method or the like can be used as a detection method of the motion vector.

The lip motion detection section 216 judges whether or not the mouth is moving. In this judgment, it is judged whether or not a motion vector exists at position coordinates of the mouth calculated in the lip detection section 214.

When judging that the mouth is moving, the lip motion detection section 216 judges to which area explained in FIG. 5A the calculated position coordinates of the mouth belongs, and inputs a code of the area to an audio processing unit 40.

As described above, in the modification example of the first embodiment, after the edge of the face and the positions of the eyes of the speaking person are detected, the mouth position of the speaking person is detected. It should be noted that an effect thereof is similar to that of the first embodiment.

### Second Embodiment

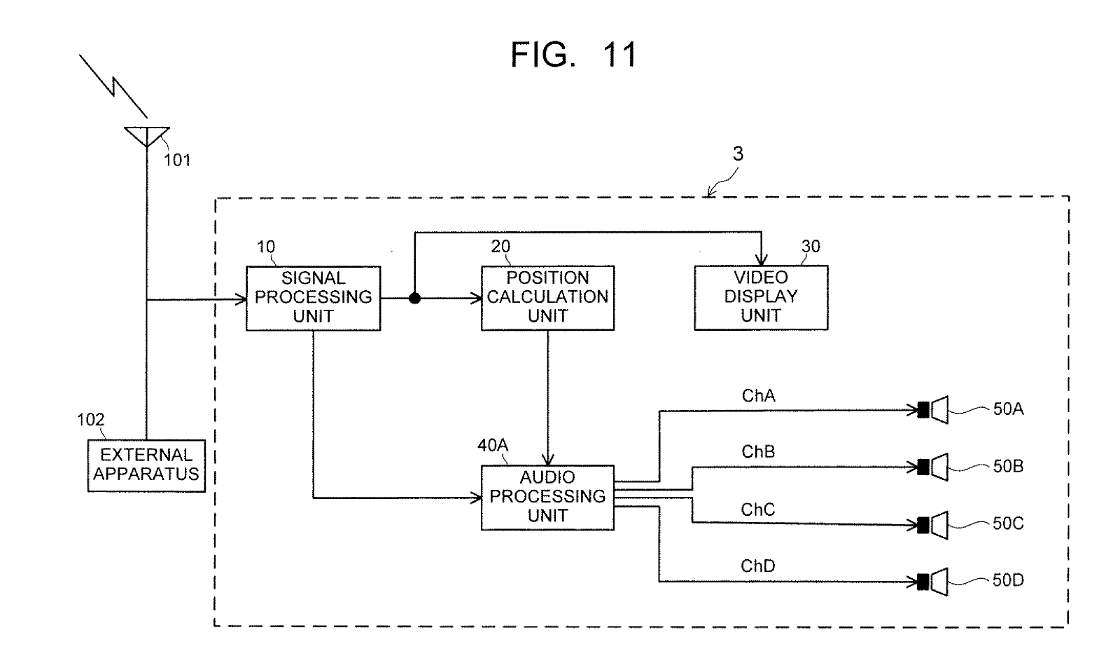

FIG. 11 is a diagram showing an example of a constitution of a video/audio processor 3 according to a second embodiment. In the first embodiment, there is described the embodiment in which the signal levels of the audio signals are attenuated as the distances between the center positions of the areas and the respective speakers 50A to 50D get longer. In the second embodiment, there will be described an embodiment in which an amplifying section 405A is included instead of the notch filter 405 and a signal level of an audio signal is amplified in correspondence with distances between center positions of areas and respective speakers 50A to 50D.

It should be noted that the video/audio processor 3 according to the second embodiment has an audio processing unit 40A with a constitution different from the constitution in the video/audio processor 1 explained in FIG. 1. Thus, in the following explanation, the audio processing unit 40A will be described and the same components as the components explained in FIG. 1 will be given the same reference numerals and symbols and duplicate explanation will be omitted.

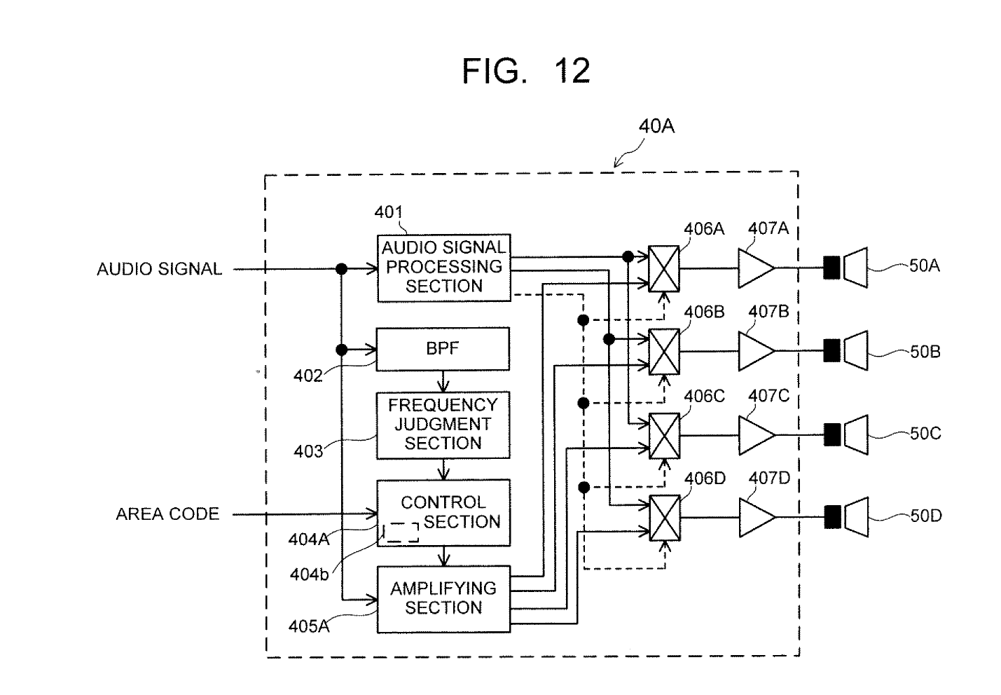

FIG. 12 is a diagram showing an example of a constitution of the audio processing unit 40A. The audio processing unit 40A includes an audio signal processing section 401, a BPF 402, a frequency judgment section 403, a control section 404A, the amplifying section 405A (adjustment section), selectors 406A to 406D and amplifiers 407A to 407D.

It should be noted that with regard to the components except the control section 404A and the amplifying section 405A the constitution of the audio processing unit 40A is the same as the constitution of the video/audio processor 1 explained in FIG. 6. Therefore, in the following explanation, the control section 404A and the amplifying section 405A will be described, and the same components explained in FIG. 1 are given the same reference numerals and symbols and duplicate explanation will be omitted.

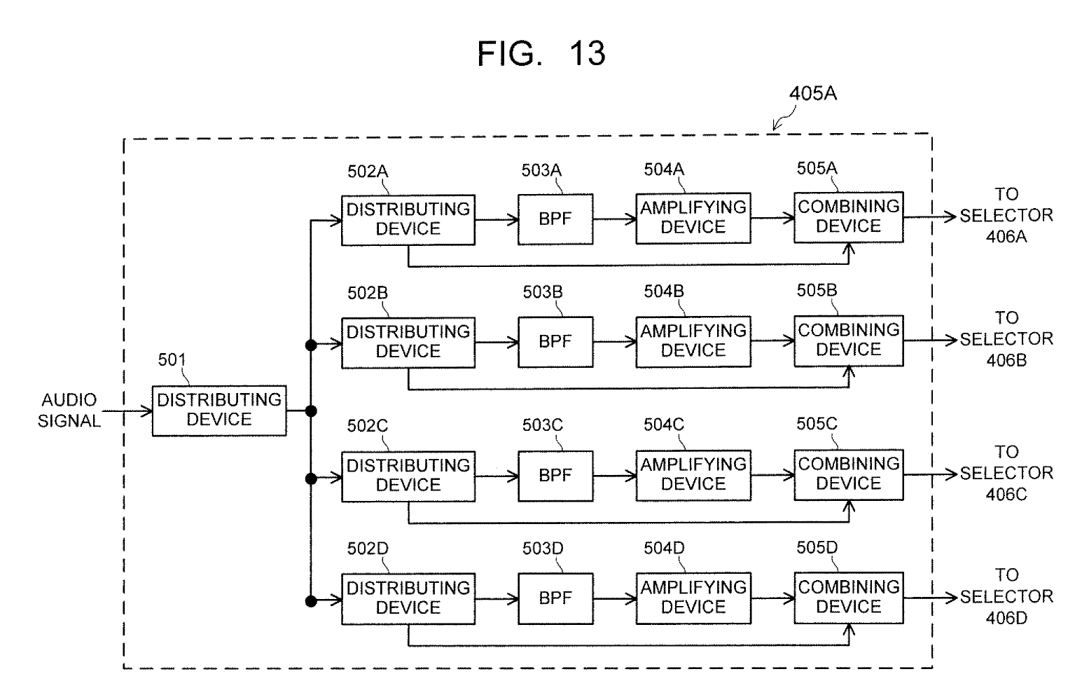

FIG. 13 is a diagram showing an example of a constitution of the amplifying section 405A. The amplifying section 405A includes a distributing device 501, distributing devices 502A to 502D, BPFs (band-pass filters) 503A to 503D, amplifying devices 504A to 504D and combining devices 505A to 505D.

The distributing device 501 distributes an audio signal inputted from a signal processing unit 10 to the distributing devices 502A to 502D. The distributing devices 502A to 502D further distribute the audio signals distributed in the distributing device 501. The BPFs 503A to 503D pass audio signals with a specific frequency band or frequency of the one audio signals distributed in the distributing devices 502A to 502D.

The amplifying devices 504A to 504D amplify the audio signals passed through the BPFs 503A to 503D.

The combining device 505A combines the audio signal amplified in the amplifying device 504A and the other audio signal distributed in the distributing device 502A. The combining device 505A inputs the combined audio signal to a selector 406A.

The combining device 505B combines the audio signal amplified in the amplifying device 504B and the other audio signal distributed in the distributing device 502B. The combining device 505B inputs the combined audio signal to a selector 406B.

The combining device 505C combines the audio signal amplified in the amplifying device 504C and the other audio signal distributed in the distributing device 502C. The combining device 505C inputs the combined audio signal to a selector 406C.

The combining device 505D combines the audio signal amplified in the amplifying device 504D and the other audio signal distributed in the distributing device 502D. The combining device 505D inputs the combined audio signal to a selector 406D.

The control section 404A includes a memory 404b. In the memory 404b is stored table data in which area codes described in FIG. 5 are corresponded with amplification amounts of signal levels of audio signals in the amplifying devices 504A to 504D.

The control section 404A sets center frequencies of the BPFs 503A to 503D of the amplifying section 405A at frequencies judged in the frequency judgment section 403. Further, the control section 404A refers to the table data stored in the memory 404b. Then, the filter control section 404A controls amplification amounts of the amplifying devices 504A to 504D to be values corresponding to the area codes inputted from the position calculation unit 20.

The amplification amounts of the signal levels of the audio signals in the amplifying devices 504A to 504D are determined in correspondence with the distances from the center positions of the respective areas to the respective speakers 50A to 50D. In the second embodiment, the amplification amounts in the amplifying devices 504A to 504D are increased as the distances between a speaking person and the respective speakers 50A to 50D get near (short).

It should be noted that the amplifying section 405A can be controlled by using an amplification ratio instead of the amplification amount as a control parameter by the control section 404A.

As described above, in the second embodiment, the amplification amounts in the amplifying section 405A are increased as the distances between the center positions of the areas and the respective speakers 50A to 50D get short. Therefore, it is possible to assign audio to a neighborhood of a position of the speaking person effectively. Consequently, an effect can be obtained that audio sounds from the neighborhood of the position of the speaking person. Other effects are the same as in the first embodiment.

### Other Embodiments

It should be noted that the present invention is not limited to the above-describe embodiments, but can be concretized with components being modified in a range not departing from the gist of the present invention in a practical phase. For example, though the embodiment is described with the example of the video display apparatus such as a liquid crystal television in the first embodiment, the present invention can be applied also to a reproducing apparatus, a recording/reproducing apparatus or the like for DVD or video tape.

What is claimed is:

1. A video/audio processor, comprising:
a position calculation unit configured to calculate from a video signal a position of a speaking person in a screen; and
an adjustment section configured to adjust a signal level of a specific frequency of an audio signal inputted to a plurality of speakers in correspondence with the position of the speaking person calculated in said position calculation unit, for each of the plurality of speakers independently.

2. The video/audio processor according to claim 1, further comprising:
a band-pass filter configured to pass a specific frequency band of the audio signal;
a frequency judgment section configured to judge a frequency of the highest signal level of the audio signal passed through said band-pass filter; and
a control section configured to set the specific frequency at the frequency judged in said frequency judgment section.

3. The video/audio processor according to claim 1,
wherein said control section controls a variation of the signal level in said adjustment section in correspondence with the position of the speaking person calculated in said position calculation unit.

4. The video/audio processor according to claim 1,
wherein said adjustment section is a notch filter or an amplifying device.

5. The video/audio processor according to claim 1,
wherein said position calculation unit comprises:
a difference generation section configured to generate a difference signal of the video signal for each frame; and
a color extraction section configured to extract a region of a specific color from the video signal, and
wherein said position calculation unit detects the speaking person from the difference signal generated in said difference generation section and the region extracted in said color extraction section.

6. The video/audio processor according to claim 1,
wherein said position calculation unit divides the screen into arbitrary regions and calculates the position of the speaking person for the each region.

7. The video/audio processor according to claim 6,
wherein said position calculation unit calculates the position of the speaking person for each area having a plurality of the regions.

8. A video/audio processing method, comprising:
calculating from a video signal a position of a speaking person in a screen; and
adjusting a signal level of a specific frequency of an audio signal inputted to a plurality of speakers in correspondence with the position of the speaking person calculated in said calculating a position of a speaking person, for each of the plurality of speakers independently.

9. The video/audio processing method according to claim 8, further comprising:
passing a specific frequency band of the audio signal;
judging a frequency of the highest signal level in the specific frequency band; and
setting the specific frequency at the frequency judged in a frequency judgment section.

10. The video/audio processing method according to claim 8, further comprising:
controlling a variation of the signal level in correspondence with the calculated position of the speaking person.

11. The video/audio processing method according to claim 8,
wherein said calculating a position of a speaking person comprises:
generating a difference signal of the video signal for each frame; and
extracting a region of a specific color from the video signal.

12. The video/audio processing method according to claim 8,
wherein said calculating a position of a speaking person comprises:
dividing the screen into arbitrary regions; and
calculating the position of the speaking person for the each region.
